(19) United States
(12) Patent Application Publication
(10) Pub. No.: US 2002/0002586 A1
(43) Pub. Date: Jan. 3, 2002

(54) Methods and apparatus for creating and hosting customized virtual parties via the internet

(76) Inventors: Howard Rafal, Somerville, MA (US); Anders Eckman, Andover, MA (US); Sidney Probstein, Brookline, MA (US)

Correspondence Address: CHARLES G CALL, 53 SAINT STEPHEN STREET, BOSTON, MA, 02115

(21) Appl. No.: 09/778,281

(22) Filed: Feb. 7, 2001

Related U.S. Application Data
(60) Provisional application No. 60/180,933, filed on Feb. 8, 2000.

(51) Int. Cl. G06F 15/16

(52) U.S. Cl. 709/205; 709/206

(57) ABSTRACT

The method of creating and hosting customized online gatherings (“parties”). One or more server computers communicate via the Internet with Web browsers operated by users. The server computer(s) store data defining one or more template web pages that implement one or more activities in which users may participate. One of the users serves as the host of the online gathering and provides a guest list identifying other invited users. In response to the host's selection of a gathering type, and possibly a specific theme for the gathering type, the server constructs a set of preliminary web pages that conform to the selected gathering type and theme. Thereafter, the host may further “decorate” the preliminary pages by supplying additional or replacement text, additional or replacement graphical image files, audio files or video clips that are incorporated into the template web pages to produce the desired customized online gathering. The host may designate a time or time range during which the online gathering will occur, and may provide an invitation list that may include email addresses of users who are then sent email invitations in advance of the scheduled gathering time. If the gathering is open only to invited users, access to the online gathering is restricted to those users who present a predetermined identification code. The online gathering as implemented by the customized Web pages comprises one or more community activities, such as chat rooms, threaded discussion bulletin boards, or picture-viewing rooms, in which invited users can view information supplied by the host or other guests. The server that executes some or all of the functions required for accepting customization data and a guest list from the host, and that handles the request/response dialog with the invited users to execute the online gathering, may advantageously take the form of an application service provider (ASP) server which operates independently of collaborating servers who utilize the services of the ASP server.

### CROSS REFERENCE TO RELATED APPLICATION

This application claims the benefit of the filing date of U.S. Provisional Application Serial No. 60/180,933 filed on Feb. 8, 2000.

### FIELD OF THE INVENTION

This invention relates to computer-controlled methods and apparatus for creating and hosting customized virtual parties via the Internet.

### BACKGROUND AND SUMMARY OF THE INVENTION

A number of Internet “community portals” have been made available which provide online forums where people can exchange information on diverse topics. Web server software that provides text-based bulletin boards and chat rooms can be used with conventional web browsers to allow users to engage in both recorded and live communications devoted to topics of interest. The capabilities of standard Web browsers may also be extended using multimedia software to permit users to engage in live audio and video two-way conferencing. In addition, server systems that support multi-user audio and video corporate conferencing are now available for direct use by consumers while servers acting as application service providers (ASPs) are available for collaborative use with other Web sites.

The ability to conduct robust live communications between participants via Web-based community portals has been further enhanced by the availability of broadband Internet connections. A rapidly increasing number of consumers have broadband access via cable modems, DSL, etc., increasing the popularity of streaming media works poorly with slower connections. As a result, multimedia conferencing is now reaching the “mass market” as evidenced by the integration of audio chat into the standard offerings of Excite, Yahoo, and others. Although these audio and video communication technologies have come into widespread use, there is a continuing need for more easily understood ways in which these technologies may be used to create and host gatherings at which participants may exchange information in a lifelike environment.

It is accordingly a leading object of the present invention to easily create and host live, private, customized group activities and events.

The present invention is based on the recognition that “parties” are a natural form of dramatically enhanced communications between individuals, and the party forms a unique metaphor that people can immediately grasp and relate to. The present invention takes advantage of this common understanding to model human experience on the Web. By enabling users to easily create and host a virtual Web party that is customized to their needs, guests can be given a readily understood and rewarding community experience.

The novel functions contemplated by the invention may advantageously be made available by Web server operating as an application service provider (ASP) for collaborative use by other Web sites. By offering a party experience to their customers, web marketers can easily expand beyond the constraints of chat and the simple posting of information to a much more dynamic and robust community offering. The invention can thus act as a vital community-building tool which will help solve key problems of all web marketers: acquiring new site visitors, encouraging repeated visits, increasing the time spent on the site, and enhancing the site visitor's satisfaction with the site.

As contemplated by the invention, a Web server, which may operate either as a standalone server, or as an ASP that operates in collaboration with one or more other Web servers, allows a user to act as a party “host.” The tools provided by the party server allow the user/host to create a customized party by manipulating a variety of parameters, varying the theme of the party and activities performed by party guests. The user/host can designate guests who are to be invited to the party by email.

When guests arrive at the online party a predetermined time scheduled by the host, they participate in the same way they would in a traditional party. Upon arrival, guests may see various “rooms” where different activities are taking place. Activities can range from listening to music to playing multi-player games to more specific interactions, such as participating in “book club” discussions. Guests can identify other guests are in each activity rooms, can choose what they want to do and who they want to do it with, and will be able to interact in various modes, such as text-based messaging and “chat rooms,” with properly equipped users being able to engage in live multi-user audio and video conferencing if they so desire.

In accordance with a principle feature of the invention, the “host” (which may be an individual or a business or organization) can create a robust customized party environment with minimal technical expertise by using easily understood tools. These tools allow the construction of diverse environments for parties, meetings, conventions, fund-raisers, reunions or any other get-together. The host selects the attributes of the party, such as the date and time of the event, the kind of occasion or “theme” of the party, the nature of the activities in which party guests may participate, and provides a guest list including the email addresses of those to be invited to the party. When the host selects a pre-programmed occasion or theme, the system automatically employs standard defaults to construct an operative party environment that embodies the selected theme. The host can them employ a variety of customization tools to modify the text and graphical elements used to create the party environment. In accordance with an important feature of the invention, the guests, too, are given the opportunity to contribute to the party's environment by posting text messages or other information or by uploading photographs and the like which will be made available to guests during the party and which can form a significant portion of the valuable content made available to party goers.

As further contemplated by the invention, gifting and purchasing functions may be integrated with the party, allowing guests to purchase gifts for one or more guest(s) of honor, to purchase party memorabilia, and perform other purchasing or gifting functions which facilitate the use of the system for fund raising affairs, promote the business of collaborating Web sites, or perform other online sales functions.

In accordance with the invention, a database system is employed or storing and updating the information needed to create a customized environment for each party. Data defining graphical “decorations” for the party, text messages, and streaming audio and video program materials are stored in and accessible to the host for creating desired party effects. The database system further accepts new multimedia data uploaded from hosts, consultants or guests for integration into the party environment. The data warehouse also manages the entire party experience from its initial draft definition through post party procedures, and constantly updates the profiles of hosts, guests of honor, and gift-givers.

These and other objects, features and advantages of the invention will become more apparent by considering the detailed description of a preferred embodiment of the invention which follows. In the course of this description, numerous references will be made to the attached drawings.

### BRIEF DESCRIPTION OF THE DRAWINGS

FIG. 1 is a block data-flow diagram which illustrates the operation of a preferred embodiment of the invention.

FIG. 2 is a diagram illustrating the a multi-server, multi-user Internet environment in which the invention operates.

FIG. 3 is a diagram illustrating the relationship between a parent party and the sub parties that optionally inherit meeting rooms and activities from the parent party.

### DETAILED DESCRIPTION

It is a principle goal of the invention is to provide consumers with a simple means for creating enjoyable Web-based parties. The terms “party” and “parties” as used herein refers to any gathering of online participants, here called “guests,” which typically occurs at a scheduled time and which facilitates the live exchange of information between those guests. The present invention enables a user, here called the “host,” to define customized web environments for the scheduled party with minimal technical expertise. This is accomplished by providing a collection of pre-programmed party types, defined by specifying “occasions” and/or “themes,” each of which consists of components that are initially specified by standard defaults. In this way, a user need only enter a minimal amount of information to obtain a customized look and feel for a party. In addition, tools are provided which enable the user to substitute different components for the provided defaults, and advanced capabilities are also provided which enable the host to newly create unique components which may then be integrated into the defined party as desired.

Roles

A user interacts with system software by logging in to a particular existing party, or indicating that a new party is to be created. Within a given party, a user has roles. Each role dictates the functionality with which a user is presented as briefly described immediately below.

The “host” is a person who builds the party, invites the guests and manages all the activities for a party. This system encourages the host's creativity. The host has comprehensive control over the details of the party experience. As the host is guided through the creation process, the party site evolves into the complete Web experience.

A “guest” is an invited participant of the party. Each guest can contribute information that form additional elements of the party. The web site displays individual contributions and lets the guest know what activities can be accessed and where all the other guests are located. During the party, guests can mingle and interact with other guests, view elements created by the host and other guests, and view and participate in activities selected by the host. If a guest is designated as a “guest of honor,” that person has all capabilities of a regular guest and further features that are selected by the host. For instance, a host can set up a shopping wallet to which each user can contribute. During the party, a guest of honor may go shopping with the wallet while other guests can watch

A “consultant” is a person who has been specially trained to use the more advanced features of the party Web site. These consultants can help create more complex party experiences for users who desire more functionality but do not wish to learn the technical details of advanced customization capabilities. Consultants may have thus have access to features and functions which are not available to guests. Since the party experience that is created by the invention is highly customizable, users can perform a rich set of standard modifications to the party being created, and use consultants to assist with more complex functions. To provide less technically inclined users with access to the advanced features of the system, the invention accordingly provides a support system for independent consultants who may provide advisory services or complete party design services. These support systems include advanced help files, training documentation, a referral system to enable users to contact independent consultants, as well as support personnel employed by the party Web site operator.

Flow

As contemplated by the invention, a party occurs in four stages: party creation, a “preparty” state, the party, and a “postparty” stage. Each stage has different activities that are performed by different participants.

Party creation is the first stage of the party process. Any registered user can create a party. When a user creates a party, that person is added to the party with a role of host. Once the party is initially created, the host can specify the general look of the party.

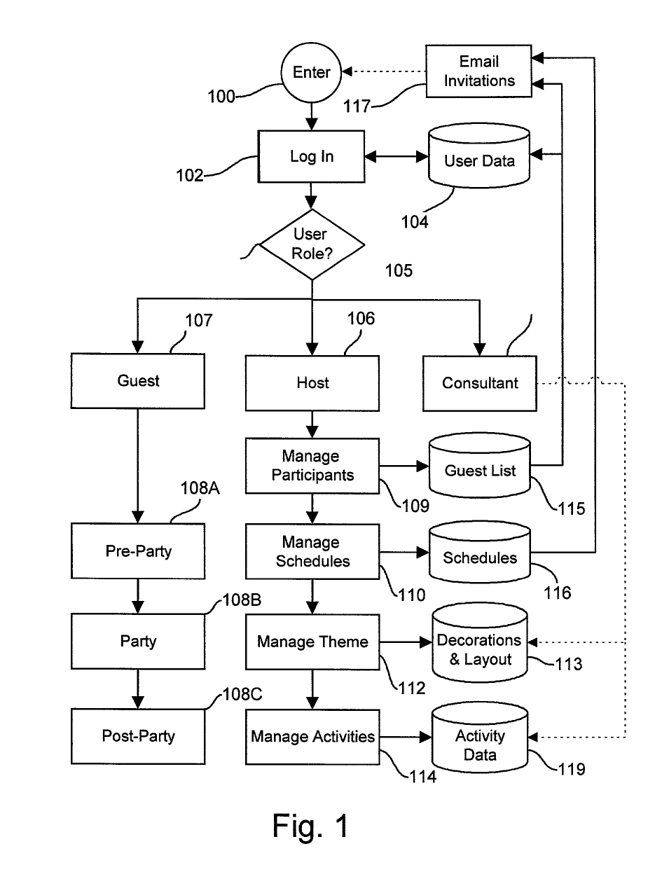

As seen in FIG. 1 of the drawings which illustrates the “preparty” stage, when any user first enters the Web site at 100, typically by accessing its home page, the user is provided with an introduction and may activate links to other Web pages which provide detailed information about various aspects of the Web site, preferably including a demonstration of its capabilities.

A “user,” as that term is employed here, can be anyone with access to an Internet connection and suitable web browsing software. As discussed in more detail later, a user with nothing more than basic and conventional web browsing software (e.g. Netscape Navigator® or Microsoft Explorer®) can participate at least to a limited extent in substantially all of the activities that are made available by the Web site; however, those users who having multi-media audio and/or video playback capabilities may experience richer content, and users capable of capturing and transmitting live sound and video images (i.e., connected microphones and/or video cameras and suitable software) for can participate in live audio and/or video “chat” sessions (teleconferencing) to directly communicate during a party with other guests.

The web browser programs, and any additional multimedia handling programs which execute on the client computer, exchange data in conventional ways using the HTTP protocol with a web server. As will be described, the web server incorporates a database system for storing information used to create the desired customized party experiences, and may be advantageously implemented by means of a conventional Web relational database server which incorporates Internet and multimedia support, such as the Oracle 8i System available from Oracle Corporation of Redwood Shores, Calif.

From the home page entry point at 100, a user can “log in” to any party as seen at 102. If the user has not previously registered as a member, an HTML registration form will be presented to obtain basic information about the user and to assign a user name and password to the user which will thereafter allow the user to perform various functions, including altering the descriptive data about that user which is stored at 104 along with the user name and password. The entry of data that the user may consider to be private (e.g., full name, address, phone number, corporate affiliation, etc.) may be made optional; however, as described later, when a host creates a particular party, the host may require that such information be entered before entry into the party is permitted. To achieve that goal, a user which supplies a correct user name and password may be presented with a party registration form which includes previously entered data from the user data store 104, requests the user to confirm the continuing accuracy of that data, and requires the user to enter any additional data specified by the host for that particular party. To protect the user's privacy, data in the user data store 104 may be encrypted or otherwise protected against disclosure to others, may be exchanged with the user only by secure protocols, and will be used only for those purposes permitted by the user.

At log in time 102, the user identifies the particular party to be created, modified or attended. The role that each entering user plays with respect to the identified party is determined at 105.

Party Creation

If the user wishes to act as the host for a newly created a new party, the party creation stage is entered at 106 to permit the host to manage participants at 109, manage schedules at 110, manage the party's theme at 112, and manage the party's functions at 114. The party creation functions seen at 109-114 can be readily implemented with conventional HTML forms in combination with CGI programs at the web server, or the equivalent. It should be noted that the designated host can re-enter the party creation stage later to modify or add to the data which defines the party.

An entry Web page may be presented to entering users that includes a drop-down selection box which accepts an indication from the users whether they are “organizing” (acting as a host), “attending” (acting as guest), or “just curious”, in which case they may view information about the capabilities of the site and view a demonstration. If the user logs into the party as a guest, as indicated at 107 in FIG. 1, the user is exposed to those functions which are available to guests participating in the pre-party stage 108A, the party stage 108B, or the post-party stage 108C, depending on whether the user enters the Web site before, during or after the scheduled time when the party occurs.

When the log-in process identifies the user as a host as indicated at 106, the host may then provide information needed to manage participants as seen at 109. The host identifies guests who are to be invited to the party, specifies which if any of the guests is to a guest of honor, and identifies any consultants who are to be given access to the data defining the party. Any new user can be given any role. Roles can be changed up until the actual party. Once the party goes into the pre-party stage, however, there may be some restrictions on editing, since some information may already be entered. The host can further designate the guest of honor, and can authorize any identified consultant to participate in the party creation process. The data defining the host, guest of honor and the consultants is stored in the user database 104. A party can have more that one user designated as a host for the party; however, a host can only change roles (or be removed) by another host. This enforces a policy of never having a party without a valid host.

The names and email addresses of each person (or group of persons) to be invited to a party are provided by the host and stored in the guest list at 115. Guest list information may be submitted using a Web page form. In addition, the system preferably includes means for importing a guest list file provided by the host. The guest list data stored at 115 may be retained, modified and supplemented for use by future parties and may be accessed with the permission of the host and transferred in whole or part to another party. Note that access to the user and guest list data remains under the exclusive control of the host

Each phase of the party will have dates and times associated with them by the host while performing the manage schedules step at 110. In addition, there will be options for setting times for RSVPs and for specific activities that are part of the pre-party. The host will have complete control of all dates within the party and the data defining the schedule is stored at 116.

A party may be recurring; that is, a party may occur weekly, monthly, annually, or at some other period defined by the host. The host may also specify at 110 the time(s) at which invitations are emailed to invited guests as indicated at 117. The invitation may take the form of standard text-only email or may be written in HTML to incorporate “decorations” from the decoration and layout data at 118 described below. In addition, the email message may advantageously include the URL of a party-entry web page which provides information about the party and further acts as the entry point for the party when it occurs, at which time the party entry point Web page will make available a log-in form for use by the invited guest.

Any party may be public or restricted only to invited guests. For most “by invitation only” parties, the guest's email address may serve as the “user's name” and no password will be required. For parties that are to be totally secure, invited guests may be provided with a user name and password by any appropriate secure means, such as a secure email transmission.

During the party creation stage, the host also chooses the party type as indicated at 112 in FIG. 1 by designating an “occasion” and/or a “theme” for the party. The host may indicate the chosen occasion or theme from a drop-down list or a “radio button” list displayed on a Web page which is then submitted to the server by the host. The occasion/theme chosen defines the party's visual presentation as well as the party's default organization. The “theme management” phase at 112 is also where the most customization capabilities are provided. The web pages that are presented to the guests during the party include graphical elements, background sounds, etc. which are consistent with the selected theme. A host may choose pre-programmed party themes which automatically provide a set of appropriate default graphical elements, sounds, video clips, etc., which are stored in a database at 113. Consequently, the database system used should include the ability to store, retrieve and publish multimedia data on the Web using conventional facilities, such as the Oracle interMedia system used with the Oracle 8i Web database system.

Decorations are the actual graphic presentations that users see when moving around the party. The activities presented to the user will function the same across different parties, but will feel very different because of the decorations that adorn the different pages. Using the advanced control features of the site, the default “decoration” elements of any theme that are stored in the database 113 may then be replaced by different elements selected from a set of available alternatives. This selection may be made visually by using the “System for manipulating graphical composite image composed of elements selected by user from sequentially displayed members of stored image sets” described in U.S. Pat. No. 5,880,740 issued to Mark D. Halliday and Karen Donoghue issued on Mar. 9, 1999, the disclosure of which is incorporated herein by reference. Alternatively, the host may upload and store a new image, sound file, video clip file, etc. for incorporation into the party. In addition, an entirely new layout may be created. This stored layout defines a set of “activities” in which a guest may participate during the party.

The layout of the party is very important to the way guests will interact with people at the party. A host can schedule activities in a way that helps navigate guests to different areas during a party. Laying out the party space will be another way to achieve some party flow. Also, the host will have some control of the actual display of individual activities. This customization control will vary by activity type. Some activities may be integrated in a highly customizable way and others may simply be linked in very rigidly. A form web page may be displayed to the host which includes a check box listing of available activities from which the host may select those activities to be made available to guests.

Activities are created and managed by the host as indicated at 114. Activities are the components of the party that together define the party experience. Each activity is defined by data stored at 119 which specify the activity's name and the attributes of a Web page which simulates a venue where the activity takes place. Activity Web pages make functions available to the guests which are selected by the host, including but not limited to: (1) a display of a list of guests currently present in the room, or thumbnail photographs or avatars which iconically represent the guests present; (2) the ability to “chat” with any selected guest(s) by exchanging email addresses or engaging in a text-based, audio, or full video-conferencing chat session with the selected guest(s); (3) participating in an interactive game, simulation or other event with other guests; (4) viewing or listening to pre-programmed performances using streaming audio or video players, with the ability to discuss that material with other guests or the presenter using the chat capability; (5) signing guest books; (6) adding content to topical “bulletin boards”; (7) participating in surveys; and (8) performing “gifting” functions as described separately in the following paragraph. These selected functions, like the “decorations” noted earlier, are pre-programmed as default components into each activity which forms part of a selected theme, but each may be replaced by a different function available in the store 119, or new functions may be uploaded into the store 119 by the host for incorporation into a customized party.

Gifts and purchasing can be an important part of the party experience. In accordance with the invention, the host is afforded considerable flexibility in defining the manner in which purchasing and gifting functions are presented to guests. For example, the host may select a “registry” function which allows a guest of honor to register gifts preferences, and then allow guests to select a gift from the registry which then records and displays the fact that the selected gift has already reserved in order to avoid duplication. For guests who don't desire to “shop” for a gift, gift certificates in any denomination may be purchased and given to the guest of honor which are then redeemable when making a purchase through the site. A party Web site may provide items that guests can purchase that will serve as keepsakes to keep the memory of the event. During the Party each guest will be provided opportunities to purchase these items. A party designed by the host to celebrate the announcement of a new line of products might advantageously afford guests an opportunity to purchase the new products. The guest of honor at a bridal shower or a birthday party may be allowed to either shop for gifts (with or without using gift certificates), or see gifts that are already purchased by other guests. If the guest of honor shops during the party, other guests will be able to see what is being purchased. If the gifts are already purchased items, the guests will be able to watch the guest of honor “open” the gifts. The host may allow the guest of honor to have some choice as to how ‘public’ the opening of gifts is, and may even permit the guest(s) of honor to choose a gifting mechanism.

Pre-party

The pre-party stage seen at 108A in FIG. 1 is the portion of the party where guests are afforded an opportunity to populate the party structure that was set up by the host during the party-creation stage. This portion of the site is much less interactive than the actual party. Users will be able to add information to activity areas, preview things already entered, contribute to gift areas and communicate with hosts and guests about ideas for the party. Hosts will be able to modify some party features, but most things will be set by the time the pre-party stage begins.

A guest joins the party by coming to the Web site (at a URL specified in an invitation or otherwise made known to the guest) and doing one of three things:

1. If the person is already registered with the site, he/she can obtain access to the party by entering their registered user name and password and selecting the particular party to which they desire access (if the user is invited to more than one pending party).

2. If the person does not have a membership, he/she can create a new membership and add by registering and obtaining an user name and password.

3. If the person is not registered, and does not wish to register, he/she can choose to remain unknown by selecting an “anonymous” user name. This provides the user with an assurance of privacy, but may be not be sufficient for entry to those parties for which the host requires that the guests identify themselves, as previously discussed.

When a guest is admitted to the party during the pre-party stage, he or she is presented with a Web page that acts as a “lobby” for the party. The lobby Web page displays the plan or “program” is for the whole party process. Dates and times for events and activities at the party will be posted. The lobby Web page provides each entering guest with a sense of when to come to the party's scheduled activities and how interactions will go. Guests will be able to e-mail the host about the calendar.

Each guest will be able to navigate through the party structure, when permitted, to add information to be displayed by or linked from the activity Web pages. When guests visit the party site during the pre-party stage, they are presented with a listing indicating those components that they are invited to contribute. For example, guests may complete a form giving additional background information about themselves, upload a picture of themselves, preselect an avatar which will represent their presence at the party, specify when they plan to attend which activities at the party (so that other guests may more easily find them), etc.

All of these pre-party options tools will be presented to the guest as specific types of party activities, rather than tools. For example, the pre-party may have an activity called ‘Remember When’ which would let guests post memories from the past using a standard bulletin board or guest book system which, in another activity where a presentation is made, might be called “Review the show.” In this way, a tool like a guest book may actually be used for many different activities. The underlying technology, to the extent possible, remains hidden and the guest (and in many cases the host) does not even know that there is a tool called a “guest book.”

The preparty contributions made by invited guests can substantially enhance the value of the party experience for all participants. While the host creates a contextualized Web site during the party creation stage, the guests populate the site with additional interesting content during the preparty stage. It is thus the combined creativity of all participants that creates the richness that the guests will share.

Party

The party stage seen at 108B in FIG. 1 is the culminating event of the party creation and preparty stages. For some pre-designated period of time and order, scheduled activities will occur live. Guests will be able to enter a party and view a web page which allows them to learn which other guests have arrived, interact with the other guests, and generally wander through the party by selecting from the available activities. A guest might enter an activity where only one person is speaking and the presence of other guests is hidden, or may enter a highly dynamic mingling area where all the guests may speak to one another using, for example, a text-based chat window displayed as part of the Web page for that activity, or alternative enter into one on one communication with another guest who is also in that room.

Post-party

After a scheduled party is concluded, the system supports a number of post-party functions performed as indicated at 108C in FIG. 1 that can be selected and scheduled by the host during the party creation stage.

Since all gifts will be purchased by known guests, the guest of honor will be able to view and print out a list of the people who contributed and what was contributed. This will allow the guest of honor to send out thank you notes. The system may also automatically mail (or email) thank you notes, charging the user if appropriate to cover the cost of the cards and postage, the Guest of Honor will be able to have The invention send out all the thank you notes. Note that the host may define a simple party, such as a “bridal shower,” which have only a registry and use the thank you card service.

The thank you card service provides choices of cards. The user can simply choose a single card type, choose a message to send and the invention will populate the cards with a message for each contributing guest (or even just a thank you for coming note). This is the simple feature. More complex features will be to allow custom messages that can still be merged with names and gift information, to choose different cards and messages for sets of guests, or to even build custom card looks.

If there is any money left in a guest of honor's account after the party, the guest of honor will be afforded the opportunity to decide what to do with the extra. There will be a slight charge for having cash mailed out, but this will decrease as the percentage of cash to gifts goes down. The intention is to eventually have gifts be discounted, so there will be some incentives built into the gifting process to have items purchased preferred over taking cash. The invention wants to encourage gifting because it is good business for partners, but it also provides those partners with advertising. This advertising is a direct means for building revenue as the site becomes more and more popular.

If the host, a guest of honor, or a guest desires a “copy” of the party, it may be captured digitally on a CD ROM, or downloaded from the party Web site after the party. Party “favors” or other party memorabilia may be offered for sale during the post party stage. The sale of such items can be used with other gifting and purchase mechanisms to stage fund-raising events for charitable and volunteer organizations and the like.

After a party is concluded, the layout and decorations used may be made available, with the host's permission, for use with future parties. Each guest who becomes a registered member of the site may be provided with a list of available party themes to encourage the use of the system. New parties can be created and and populated with information from a prior party.

Since parties may be repeating events, and may be associated with real world events, reminders may be automatically sent to past Hosts that an event is coming up. For instance, a birthday Party can result in annual reminders. A host-accessible reminder system may be used to automatically send reminders to hosts.

Integration with Other Web Sites

In order to minimize or eliminate costs or fees to hosts or guests that create or participate in a party, the party may be sponsored by one or advertisers. In return, the sponsor's advertising is displayed as part of the “decorations” for the party. When a plurality of sponsors are available, the host may be allowed to select a sponsor. In addition, a sponsor may choose to sponsor parties having particular themes; for example, a manufacturer or reseller of infant care products may choose to sponsor parties for which the “baby shower” theme was selected.

The party experience provided by the invention may also be made available through the auspices of a Web site managed by a third party sponsor. For example, the sponsor may be college web site that stages virtual reunions for alumni, or a corporate Web site which hosts a “convention” for its customers. The mechanisms described above for creating and staging the party may operate on a first server that acts as an application service provider (ASP) on behalf of the sponsor's web site. The fact that the party functions are being performed by the ASP Web site is largely transparent to the customer, since the layout and decorations used for the party are provided as discussed above by the host/sponsor. The ASP party functions contemplated by the invention can thus provide party experiences through many other web sites by providing its basic engine for use over the Web. The guests experience a party that seems to be occurring on the customer's web site even though it is really not.

The data kept by the ASP Web site can be minimized to essential information. For instance, the decoration and layout data 113 and the activity data 119 which is available for shared use by different collaborating websites is stored in the ASP server 130 whereas data the schedule data 116, the guest list 115 and the user data 104 which is unique to a particular party or host is stored on the collaborating server 132. The storage of private data on the sponsor's server allows the sponsor to handle authentication and then identify users by its own chosen mechanism. This separation of data also allows the ASP to provide party experiences for many different web sites without having to track all the user information that might be kept by these different sites.

The ASP party functions can be used to particular advantage to provide a sense of “community” to existing e-commerce sites in which the purchasing and gifting functions can be handed by the e-commerce site. Thus, for example, an online bookseller might use the ASP party server to stage scheduled virtual book signings and book group meetings where the bookseller's customers could share views about a given book, order autographed copies, and see or hear an interview with the author. These events would appear be part of the bookseller's Web site but would actually be provided by the ASP server. When the party functions are supplied on an ASP basis to an e-commerce web site, the ASP sited does not provide the shopping/buying tools itself but instead works with the sponsor's Web site which does provide these features. So, much like keeping user information to a minimum, it will be important for the invention to be able to query about gifting/buying transactions, but not keep this information directly. By leaving this as an external system, other web sites can utilize some important features of the invention but still handle E-Commerce with whatever tools it already is utilizing.

Any sponsoring Web site with which the ASP party web site is integrated needs data indicating how well the service is working for them. Since the ASP site is responsible for maintaining a large amount of interactive information, sponsoring Web sites should be given access to at least selected system usage data. This access may provided in conventional ways, such as by making relevant system log files available in an FTP directory which is accessible to the sponsoring Web site.

Deployment Architecture

The present invention is implemented by one or more servers that support three functions. (a) the registration and maintenance of date defining user profiles and the selection of parties; (b) the creation and design of customized virtual parties; and (c) the performance of the virtual parties as defined. In its simplest form, the invention is implemented on a single server as a stand-alone system with it's own database, and software to handle registration, creation and management of parties, and allow users to attend parties. Each standalone server can serve multiple party sessions and accommodate multiple users in each session.

In more a complicated configuration, a central database server provides data services for multiple participating satellite servers, including:

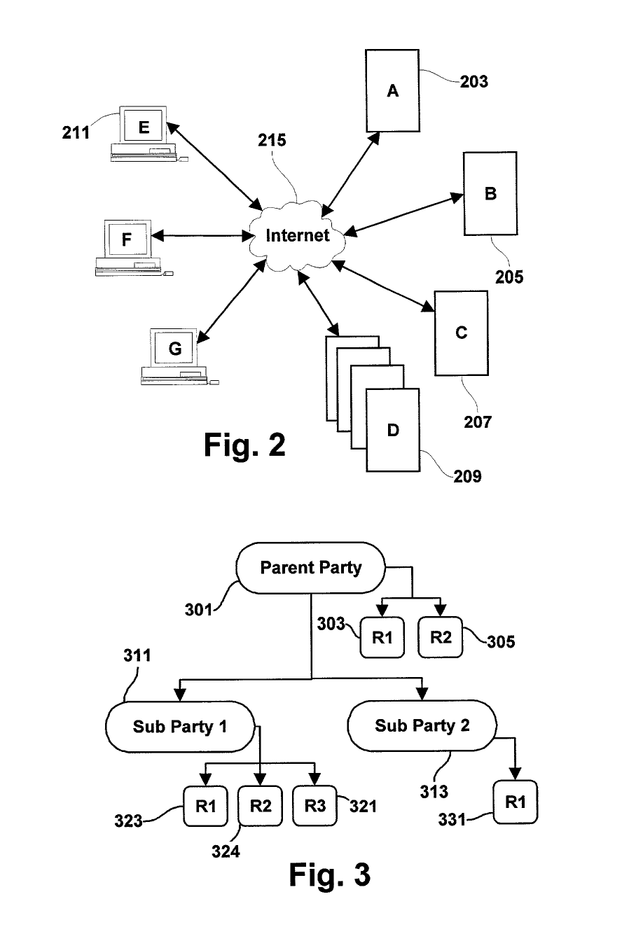

a. Individual servers each dedicated to a single host, which accepts guests via invitation to that host only. For example, as shown in FIG. 2, server A at 203 may be a stand-alone server which serves a single sponsor, but may host multiple parties on behalf of that sponsor, including “sub-parties” as described later. The attendees who participate in parties hosted by the server A may be limited by an address list specified by the single sponsor.

b. A web site presented by the server B illustrated at 205 in FIG. 3 may sponsor a party by directing users via links to a server D or C that provide all of the virtual party functionality and operate as an application service provider with respect to server B. The sponsor of the web site presented by server B thus provides visitors with a virtual party experience without needing to implement the necessary functions on server B.

c. Server C at 207 may perform any or all of the major functions performed in hosting virtual parties, and may directly host multiple parties, may directs users who register for parties to perform functions hosted by other servers, such as server D at 209, and may provide functions to user who are directed to server C from other servers, such as server B

c. Multi-server installations as indicated by the server installation D at 209 may serve thousands of users, and may divide functions among separate servers at the installation. For example, one server may be a database server which handles registration; a second server may handle system accounting functions; a third may be act as an SMTP and POP email server host for handling invitations; and other servers may devoted to providing special functions or supporting specific ASP clients.

Thus, the user of a browser at 211 can establish a connection to any of the servers 205-209 via the Internet seen as 215. The user of the browser may, however, will be permitted to participate in only those “invitation only” parties to which he or she has been invited.

If the user of browser 211 is visiting the web site published by server A at 203, it receives web pages produced by the web server A without the participation of any other server. If the user of browser 211 visits the web site published by server B at 205, he may be referred by a link or redirection message to connect to ASP server C at 207 or server D at 208 which provides the a virtual party session without the browser user being aware that the party is being hosted on a server different from server B. If the user visits a web site hosted by server C at 207, functions such as registration and the principal virtual activities may be provided by the server C while specialized functions, such as special event multimedia experiences, may be hosted on another server such as server D at 209.

The software contemplated by the present invention contemplated by the present invention and described below is preferably capable of supporting all these potential configurations. To that end, the software must be designed for scalability at the server level. Each server should be able to service a simultaneous load of 250 active users, each of which may concurrently view pages and chat via HTML web pages using java-script or plug-in components with no significant delays in performance.

### Server Requirements

The server(s) that support the functionality required by the present invention should have additional capabilities and characteristics that are briefly summarized in this section.

Tracking Mechanisms. The activity of each user is be tracked by using a unique identification code assigned to that user. This code may be used to access user identification information created during each session that includes:

a. the IP address used by the user during the session;

b. the date and time of the user's arrival at the sight (i.e., the date and time of the first HTTP request message from that user;

c. The referring URL, or a coded equivalent, with a default value if not listed, as specified in the first request message from the user; and

d. The entry point URL (or a coded equivalent, with a default value if not listed)

All additional user and session information stored on the server(s) is indexed by and accessible using this code. The code should be stored on the user's browser as a cookie enabling the user to be identified in later sessions. In the event that the user does not accept cookies, the code is generated and maintained by the server for the duration of the session.

URL Display. When server(s) that support virtual party functions place links or other visible URLs on generated web pages, these URLs preferably contain as little visible information as possible. In this way, the server can provide functionality to branded web sites without causing confusion in the mind of the user. For this reason, URLs containing user or session ID coded values are acceptable, but other data should be hidden. In general, scripts should make use of the POST mechanism rather than GET.

Uploading Support. The ability to provide graphical and multimedia content to individualize the experience of each virtual party is an important feature of the invention. Because users will be able to add binary content (including images, audio and video) to the data stored and published by the servers, the server platform must support this activity. Although FTP file transfers may be used, it si preferable to support uploads of binary data from users using full HTTP/PUT support, with client-side browsing support.

Secure Server Support. The server should provide the secure transmission and storage of data supplied by users to protect their privacy, and hence should support the Secure Sockets Layer (SSL) during registration.

Template Based System. For reliability, speed and extensibility, the server(s) and software preferably employ a template-based approach to the generation of web pages rather than storing page definition data in a database. As users provide data to select preferences and customized entries, that data is used to modify standard HTML template pages, XML documents and/or other markups to generate web pages which may be viewed and approved by the designer, modified if desired, and then published to party visitors. Database-only representations of pages should be avoided.

Interface Standards. In order to promote interoperability with other sites, support easy importation of existing data for use in customizing the virtual parties, and to permit the use of standard development tools wherever possible, standard protocols should be observed wherever possible. The use of XML is particularly desirable for transmitting and storing since it enables user data to be readily integrated with standardized templates using XSL, permitting the content to be varied as desired by the user but still be readily validated and integrated with the functional components of the system.

Hierarchical Party Structure

Parties may be defined in parent-child relationships in which attendees who are invited to a parent party are allowed to define and sponsor “sub parties.” Initially, a root or top-level parent party is defined by a server administrator on behalf of a party sponsor. As illustrated in FIG. 3, the parent party 301 may be defined to have two activity rooms R1 at 303 and R2 at 305. Any visitor to the parent party 301 may define and create sub parties as illustrated in FIG. 3 by sub party 1 and 311 and sub party 2 at 313. Users may enter a parent party using an “invitation” (unique code) to the parent party, and if permitted by the invitation, may create a sub party. An invited user who creates a sub party is the host of that sub party and may define its characteristics.

Sub parties may selectively inherit the characteristics of the parent party. Sub party 311 when created by its host defined a new activity room R3 seen at 321 which may be entered only by guests entering sub party 1 (311). Sub party 1 also inherits and makes available new instances of rooms R1 and R2 as indicated at 323 and 324. The guest invited to the parent party who creates sub party 1 at 311 may modify (override and/or add to) the characteristics of the inherited rooms. Said another way, the rooms 303 and 305 defined for use by the parent party 301 are available as templates for optional use in a sub party, but need not be used as illustrated by the sub party 2 an 313 which used only room RI inherited from the parent party as seen at 331, but did not use room R2.

Inherited rooms are entirely separate instances. Thus, visitors to room R1 at 303 in the parent party do not interact with visitors to the inherited room R1 at 323 in the sub party. Inherited rooms have the same décor, content, etc, as initially copied from the room of the parent party, but these room properties may be modified by the host of the sub party.

Each party or sub party comprises a set of connected, customized “party rooms”, each of which is derived from the binding of a “room template”, that supports “decoration” and “navigation”, with an “activity template” that supports one or more “activities”.

Room Templates

A room template defines the general format of rooms within a party. It includes space for the room name, party navigation, advertising, and allows for the binding of decorations. A room template is decorated with a single, party-wide “decoration scheme”, which may consist of the following elements:

a. Page background (graphic)

b. Room name (font, color, background, text effects)

c. Navigation (font, color, text or button style, etc)

d. Additional fixed elements (e.g. a party entrance graphic, etc)

A room template may be implemented as a text file containing an HTML template web page with imbedded markers corresponding to the variable elements. When a user selects from the available element options, or uploads graphical elements in the form of .gif or .jpg files, the markers in the template are replaced by HTML segments which contain or reference the submitted information from the user. The resulting HTML page may then be displayed to the user.

Alternatively, the room template may take the form of an XML document containing standard content which is merged using an XSL transformation with an XML document containing the variable content supplied by a user to form a new XML document which may then be converted into displayable form using a client-side or server-side XSL transformation to HTML form, or may rendered using a CSS stylesheet by the browser. Suitable XSLT transformation software are widely available and the techniques for transforming XML into displayable Web page format are described, for example, in Professional XML by Anderson et al., ISBN 1-861003-11-0, Wrox Press (3000). Complete specifications and documentation on XML, XSL, and CSS are available from the World Wide Web Consortium at www.w3c.org.

The room template provides built-in support for navigation between all party rooms, and to other site functions such as the User Console. If the parent has selected the RequireLink property, all sub-parties of that party will offer a link to the parent party in the navigation scheme. Users who are hosts and who have administrative access privileges view Web pages which further include a navigation link to the Party Management Console.

Activity Templates

An activity template defines the formatting and components for a particular activity and may be copied into or provided as an initial component of a room template.

The list of desired party rooms is defined at party creation time. Each room definition includes the name of the room and the activity that will occur within that room. Rooms are listed in alphabetical order by name for review by the party or subparty host. If the activity includes host-defined or user-defined content, that content is stored on a per-room basis, not per-activity. In other words, if there are two rooms of the same type (e.g. a photo album), photos uploaded for display in one room will not be available in the other room.

User Console

The user console provides features and functions which are available to any user who is not entering, or actually engaged in a party. The user console allows a user to enter an invitation code to gain entrance to an invitation-only party, as well as an entry link to one or more public parties that do not require an invitation.

The user console is driven by two server-level configuration options. The first allows co-branding of the user console for that server. When set, this option places the co-branded partner's logo in a fixed position on the user console screen, providing equal exposure with the logo of the party's primary host. The second option limits the list of parties available to the user to those on the host's server, and not all those on the network of participating party servers.

Users may be required to login with a username and password. Although users are considered ‘logged in’ if they have entered an invitation code, they may not have provided desired registration information if they do not have a username and password. If desired, the user may be required to register before entering a party. Registration typically obtains information from the user such as: first name, last name, address (two lines), city, state, country, zip or country code, email address and daytime telephone number. Some of these entries may be mandatory and the others optional. Mandatory data must be properly submitted before the user is allowed to proceed to view the list of available parties.

Once logged in, the user will be presented with a list of parties are available, including both open or “public” parties and parties to which the user has been invited as determined from the user's invitation code. If the user is logged in, and is a host for any party, the user console will display a link to the Party Management Console.

Party Management Console

The party management console permits the user to customize selected parties. Parent party hosts may access management features for their party, or for any sub-parties. Party hosts may access features only within their own sub-party. The party management console provides the following functions.

Create/Edit Party

Creating a parent party is only possible for a user with administrator access. Sub parties may be created only for parent parties that allow sub parties. Party creation consists of the following phases. When all the phases are complete, the party is ‘activated’ and can be entered by the hosts. Guests may not enter until the start time is reached.

Setting properties. The host is permitted to review and set properties using HTML forms-based exchanges with the server. Pull-down lists are used to allow selection of code values where possible. Direct input, when required, is appropriately validated.

Defining the invitation list. Invitations are transmitted to invited persons using a list of addressee names and their email addresses. The text of the invitation may be prepared by the user/host. Plain-text invitations are preferred since many potential recipients use email client software that does not support HTML email or graphics. The outgoing email typically includes a link to the URL for the server providing the entrypoint for the party or parties to be made available to the invitation recipient. The recipients “invitation code” may be specified in the email text, or may be made a part of the URL for automatic submission to the hosting server.

Selecting post-party activities. The party creator may choose to invite party hosts and attendees to engage in various post-party activities. One such activity is typically required of all visitors: a simple user survey. The party creator should be able to choose to offer this activity;

create the text for the post-party email, which will include a link to the survey script; and schedule the date/time to distribute the post-party email.

Selecting the decoration scheme. The party host is required to initially select one of the supplied decoration schemes. The administrator of the system creates an assortment of decoration schemes.

Selecting activities. Activity selection is performed for parent parties only. The party creator must define the activities that will be available to the party, and any sub-parties.

Creating the room list. This phase allows the host to define the party rooms they want in their party. This process includes:

Naming the room

Choosing the activity for the room

Setting parameters for the activity within that room

Optionally, organizing the rooms (if not organized, rooms are listed alphabetically)

Adding content to rooms. This phase allows the host to add content to activities within rooms. For example, photos may be uploaded and added to a photo gallery room, or add music files may be uploaded and added to an entertainment room.

Removing content. Users who are also hosts may remove content from activities within their party, or if they are parent-hosts, within any sub-party. When viewing content, such users see an optional “remove” link next to it.

Excluding Guests. For parties that require registration, hosts may block a particular user from entering the party. For parties that require a unique invitation code for each visitor, users presenting a blocked invitation code are denied the right to enter the party.

Party Activities

As used in this specification, the term “activities” broadly refers to a number of related structures and data, including but not limited to:

The software, templates and content to support the activity

The parameters for configuring the software that supports the activity

The URL for the activity on the supporting server

Specific modes of interactive information exchange with and between users, including those described below.

Chatting. Chatting can be, and preferably should be, supported by a variety of mechanisms which are selected based on the capabilities of the client. These mechanisms include HTML form page exchange as well as live connections implemented by Java or plug-ins. Chatting is preferably limited to users within a single activity room; that is, inter-room chatting is not supported. The mechanism that support chatting may, however, be shared by various rooms, and may be shared between multiple servers, if the party is hosted on multiple servers. Users in any chat room should be able to optionally enter a ‘private’ mode for 1-on-1 chatting.

Photo album. The photo album activity allows browsing of multiple images, in JPEG and GIF formats. This activity is normally ‘locked’ so that images can only be added by the party hosts, but can be “unlocked” to permit image sharing among visitors.

Audio delivery. The audio delivery activity allows users to listen to music or other audio program segments. The user may select the file they wish to hear, in the format they wish to receive it. Like image delivery, the audio delivery activity is typically be ‘locked’ so that the recordings can only be added by the party hosts, but can be unlocked so that audio files may be posted in an activity room by a visitor for playback by other visitors to that room.

Video delivery room allows users to watch streaming video files. The user may select the file they wish to view, in the format they wish to receive it. This activity too may be ‘locked’ so that video files can only be added by the party hosts, or unlocked to permit sharing of video files among visitors to a given activity room.

When image, audio or video file sharing is permitted in an activity room, the host should actively discourage the posting of copyrighted works without permission from the copyright owner. For example, warnings should be displayed during the file upload stage to advise users that sharing copyrighted works without permission may constitute a copyright violation.

HTML Content Delivery. An HTML content delivery activity allows users to review static HTML such as a brochures. For example, the host may wish to create a resource room which features links to other HTML pages which are made available for party visitors.

Messaging. The messaging activity preferably supports several modes in which users can post text message to one another. A messaging activity may take one of the following forms:

Guest Book. Substantially all parties will feature a “guest book” activity in which visitors are requested to sign in and post comments. The guest book does not permit replies to be posted, nor does it permit later editing of the posted sign in message.

Threaded Bulletin Board. This activity provides a standard, “Use-Net” style discussion. Users may post new messages, or reply to old messages. Threads are tracked by subject. Editing of messages is not possible.

Buying. The buying activity presents a directory of products that the hosts will to expose to the party guests. Buying content is typically ‘locked,’ but could be unlocked to support a “swap room” exchange or “flea-market” in which users may sell or trade goods or services with other visitors to that room. Product directory entries preferably consist of a product photo, text description of the product, a price, and a link to a sales site supported by merchant software (i.e., shopping cart and credit card checkout capabilities). The sales site may be operated the host or a participating merchant.

Administration Console

The administration console is available only to users with administrator access and provides an entry point for the following functions:

Create Users. This function is similar to the Registration (and Update Registration) function noted earlier, but permits all user access properties to be edited, including the specification of user access level privileges granted to users.

Party Status. This feature displays the number of users on the server, broken down by party code, and an estimate of the relative load on the server.

Party Control. This feature permits the administrator to suspend or resume a party.

Party Termination. This function terminates a party and moves it's assets (including chat transcripts, text messages, guest books, image/audio and video files) into a storage area for archival purposes. Once a party has been terminated, it cannot be resumed via the Party Control above.

Content Monitoring. This function allows an administrator to review all content additions on a specified server, a specified party, or a specified party-room. All content supplied by either administrators or users may be reviewed, including all text (including chat and message postings), images, video and audio. The administrator will have the ability to remove any binary content, or to expel a user who posts improper content.

Reporting. The administrative console allows reports to be produces in the form of exported data files which summarize the activity and attendance at a party (including, optionally, all-sub parties), including: the number of visitors, the number of sessions, the average session length, the mean session length, cluster of session length, the number of advertising exposures, and a summary of activity usage.

Display Formats and Standard Features

Advertising Display. Parties are typically presented using frames, including a top from for holding rotating adverting banners or the like. A consistent “navigation bar” may be included in the same frame with the advertising content, or in a separate frame.

Survey Script. Visitors will typically be asked to complete a standard user survey questionnaire which collects data using input text boxes, boolean check boxes, or and option selectors (radio buttons). The standard user survey is completed by all party visitors and is used to aid the system administrator in measuring the utility of shared system features. User survey data should be stored in a separate database table, but entries include host, party, and user identification keys so that data may also be selectively reported on a per host, per party or per user basis.

Conclusion

It is to be understood that the illustrative preferred embodiment of the invention which has been described is merely illustrative of one application of the principles of the invention. Numerous modifications may be readily made by those skilled in the art without departing from the true spirit and scope of the invention.

What is claimed is:

1. The method of using the Internet to create and host a customized online gathering of participants comprising, in combination, the steps of:
providing at least one server computer connected to the Internet for communicating with a plurality of client computers operated by users which are also connected to the Internet,
storing at said server computer:
a) template data defining one or more template web pages, each of said template web pages implementing a predetermined activity in which said users may participate as part of said online gather,
b) an identification of said first user as the host of said online gathering,
c) a guest list accepted from said first user identifying a plurality of other invited users, and
d) customization data accepted from said first user,
combining said template data and said customization data to create customized web pages which together implement said customized online gathering,
establishing an authorized connection via the Internet between said server computer and each of said invited users that choose to participate in said gathering and,
responding to requests received from any given one of said invited users by transmitting to said given user one a requested one of said customized Web pages.

2. The method as set forth in claim 1 wherein said guest list includes the email addresses of at least some of said other users and further including the step of transmitting an invitation to said gathering to each of said email addresses.

3. The method as set forth in claim 1 wherein said customization data accepted from said first user includes the designation of a gathering type and wherein, in response to said designation of said gathering type, said server computer automatically establishes a set of predetermined default values for said customization data which are combined with said template data to produce preliminary customized pages.

4. The method as set forth in claim 3 said gathering type is designated by the combination an occasion type and a theme associated with said occasion type.

5. The method as set forth in claim 3 further including the steps of accepting from said first user replacement attribute values which may be substituted for particular ones of said default values to modify said preliminary customized pages.

6. The method as set forth in claim 1 wherein said at least one server computer comprises a first server which acts as an application service provider for presenting said Web pages to users who access at least some of said Web pages using addresses supplied by a collaborating server computer.

7. The method as set forth in claim 1 wherein at least a given one of said template web pages implements an activity in which said invited users may communicate with one another, said method including the further steps of accepting contributed data from one or more of said other invited users, storing said contributed date on said server computer, and thereafter displaying at least selected contributed data as part of said given one of said Web pages.
